(19) United States
(12) Patent Application Publication
(10) Pub. No.: US 2024/0089409 A1
(43) Pub. Date: Mar. 14, 2024

(54) SERVER AND METHOD FOR REMOTELY PROVIDING VIDEO SERVICE AMONG PLURALITY OF PARTICIPANTS EXPOSED TO MULTI-CAMERA ENVIRONMENT

(71) Applicant: Daekyeong MOON, Seoul (KR)

(72) Inventor: Daekyeong MOON, Seoul (KR)

(21) Appl. No.: 17/944,277

(22) Filed: Sep. 14, 2022

(51) Int. Cl. H04N 7/15; H04L 12/18; H04N 7/14

(52) U.S. Cl. CPC H04N 7/152; H04L 12/1822; H04L 12/1831; H04N 7/147

(57) ABSTRACT

Provided are a system and method for remotely providing a video service among a plurality of participants exposed to a multi-camera environment by a server. The method includes receiving first participant videos from two or more cameras of a first participant, receiving second participant videos from at least one camera of a second participant, and transmitting the first participant videos to a second participant terminal and transmitting the second participant videos to a first participant terminal to output all the first and second participant videos to the first and second participants. The first or second participant videos are changed by an input manipulation made through at least one of the first participant terminal and the second participant terminal and output to the first and second participants.

### BACKGROUND

### 1. Field of the Invention

The present invention relates to a technology for remotely providing a video service through a wired or wireless network.

### 2. Discussion of Related Art

The tele-education industry, which is a continuously growing industry, is expected to grow to a value of 342 billion dollars worldwide by 2025. In particular, the demand for tele-education is rapidly increasing amid the outbreak of coronavirus disease-19 (COVID19). However, tele-education tools do not meet such expectations. Tele-education tools are limited to unilateral transmission of videos or simple matching, raising skepticism about tele-education.

Several efforts have been made to improve tele-education tools, but there are still limitations. For example, video conferencing tools, such as ZOOM, provide only limited functions, a face screen function and a screen sharing function, and thus are evaluated as lacking in realism, immersion, and achievement. Since video conferencing tools are for business, they may be effective only for language learning in which it is only necessary to look at each other's faces. Telecommunication companies that provide fifth generation (5G) communication services are also trying to use their own communication infrastructures, but there is a problem that they do not have specific methods and that the curriculum should be digitized. Also, a remote tool employing artificial intelligence (AI) may provide only standardized description rather than description distinguished between individuals.

Accordingly, the inventor of the present invention has spent a long time researching a remote video service provision method for strengthening realism and increasing interaction between participants and completed the present invention through trial and error.

### SUMMARY OF THE INVENTION

In this background, the present invention is directed to providing a technology for collecting a participant video including the environment of each participant from at least one camera of the participant, outputting all participant videos to each participant terminal, changing one participant video according to an input manipulation of one participant, and outputting the changed participant video to all the participants.

The present invention is also directed to providing a technology for outputting participant videos in a region of attention and a peripheral region in the screen of a participant terminal and outputting some of the participant videos on one side of the region of attention or one side of the peripheral region as thumbnails.

The present invention is also directed to providing a technology for receiving a manipulation for a participant video output as a thumbnail and outputting the participant video in the entire region of attention in one participant terminal or simultaneously outputting the participant video in the entire region of attention in all participant terminals through the received manipulation.

According to an aspect of the present invention, there is provided a method of remotely providing a video service among a plurality of participants exposed to a multi-camera environment by a server, the method including receiving first participant videos from two or more cameras of a first participant, receiving second participant videos from at least one camera of a second participant, and transmitting the first participant videos to a second participant terminal and transmitting the second participant videos to a first participant terminal to output all the first and second participant videos to the first and second participants. The first or second participant videos are changed by an input manipulation made through at least one of the first participant terminal and the second participant terminal and output to the first and second participants.

The first participant videos may be output in a region of attention in a screen of the second participant terminal and a peripheral region in a screen of the first participant terminal, and the second participant videos may be output in a region of attention in the screen of the first participant terminal and a peripheral region in the screen of the second participant terminal.

The first and second participant videos may be output on the screen of the first participant terminal and the screen of the second participant terminal as thumbnails.

When the first participant terminal receives an input manipulation for thumbnails of the first and second participant videos from the first participant, the first and second participant videos may be output in an entire region of attention in the first participant terminal, and when the second participant terminal receives an input manipulation for the thumbnails of the first and second participant videos from the second participant, the first and second participant videos may be output in an entire region of attention in the second participant terminal.

When the second participant terminal receives an input manipulation for a thumbnail of the first participant video from the second participant, the first participant video may be simultaneously output in an entire region of attention in the second participant terminal and an entire peripheral region of the first participant terminal.

When the first participant terminal receives an input manipulation for thumbnails of the first and second participant videos from the first participant or the second participant terminal receives an input manipulation for thumbnails of the first and second participant videos from the second participant, the first and second participant videos may be simultaneously output in entire regions of attention of the first and second participant terminals.

The method may further include receiving an input manipulation from a participant terminal which is given authority to change videos, changing the first or second participant videos in accordance with the input manipulation and providing the changed participant video to the first and second participant terminals, and generating participant attention information representing a changed state of the first or second participant videos and providing the participant attention information to the first and second participant terminals.

The method may further include giving administrative authority to the first or second participant terminals, and the administrative authority may include authority to change videos for changing the first or second participant videos and authority to access participant attention information representing a changed state of the first or second participant videos.

According to another aspect of the present invention, there is provided a server for remotely providing a video service among a plurality of participants exposed to a multi-camera environment, the server including a communicator configured to transmit or receive information or data to or from a first participant terminal manipulated by a first participant and a second participant terminal manipulated by a second participant, and a controller configured to, through the communicator, receive first participant videos from two or more cameras of the first participant, receive second participant videos from at least one camera of the second participant, transmit the first participant videos to the second participant terminal and transmit the second participant video to the first participant terminal to output all the first and second participant videos to the first and second participants, and receive an input manipulation from at least one of the first participant terminal and the second participant terminal. The controller changes the first or second participant video in accordance with the input manipulation and provides the changed first or second participant video to the first and second participants.

The communicator may transmit or receive information or data to or from a third participant terminal manipulated by a third participant, the controller may transmit a third participant video to the first and second participant terminals to output all the first to third participant videos to the first and second participants, receive the input manipulation, change the first to third participant videos in accordance with the input manipulation, and provide the changed first to third participant videos to the first and second participant terminals, and when the second participant terminal receives an input manipulation for the first participant video from the second participant, the first participant video may be output in the entire region of attention in the second participant terminal, and the peripheral region of the first participant terminal may be maintained in a previous output state.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a configuration of a system for remotely providing a video service in a multi-camera environment according to an exemplary embodiment;

FIG. 2 is an example diagram of a screen output by one of a plurality of participant terminals according to an exemplary embodiment;

FIG. 3 is a set of block diagrams of a server and a participant terminal according to an exemplary embodiment;

FIG. 4 is an example diagram of a participant attention state output by one of a plurality of participant terminals according to an exemplary embodiment;

FIG. 5 is a first sequential diagram illustrating operations of a system for remotely providing a video service in a multi-camera environment according to an exemplary embodiment;

FIG. 6 is a second sequential diagram illustrating operations of a system for remotely providing a video service in a multi-camera environment according to an exemplary embodiment;

FIG. 7 is a third sequential diagram illustrating operations of a system for remotely providing a video service in a multi-camera environment according to an exemplary embodiment;

FIG. 8 is a set of example diagrams of a case in which a student and a teacher participate in a system for remotely providing a video service in a multi-camera environment according to an exemplary embodiment;

FIG. 9 is a first example of screens output by terminals of a student and a teacher when the student and the teacher participate in a system for remotely providing a video service in a multi-camera environment according to an exemplary embodiment;

FIG. 10 is a second example of screens output by terminals of a student and a teacher when students and the teacher participate in a system for remotely providing a video service in a multi-camera environment according to an exemplary embodiment;

FIG. 11 is a set of example diagrams of a case in which a student, a teacher, and parents participate in a system for remotely providing a video service in a multi-camera environment according to an exemplary embodiment; and

FIG. 12 is an example of screens output by terminals of a student, a teacher, and parents when the student, the teacher, and the parents participate in a system for remotely providing a video service in a multi-camera environment according to an exemplary embodiment. The accompanying drawings are exemplified by reference for understanding the technical spirit of the present invention, and do not limit the scope of the present invention.

### DETAILED DESCRIPTION OF EXEMPLARY EMBODIMENTS

In the description of the present invention, when it is determined that the subject matter of the present invention may be unnecessarily obscured by related known functions which are obvious to those of ordinary skill in the art, the detailed description thereof will be omitted.

Terminology used herein is for the purpose of describing embodiments only and is not intended to limit the present invention. Singular forms include plural forms as well unless the context clearly indicates otherwise. The terms “include” “have,” etc. used herein specify the presence of stated features, integers, steps, operations, elements, parts, or combinations thereof and do not preclude the presence or addition of one or more other features, integers, steps, operations, elements, parts, or combinations thereof.

Hereinafter, exemplary embodiments of the present invention will be described in detail with reference to the accompanying drawings. In describing exemplary embodiments with reference to the accompanying drawings, the same or corresponding elements will be given the same reference numeral, and the overlapping description thereof will be omitted.

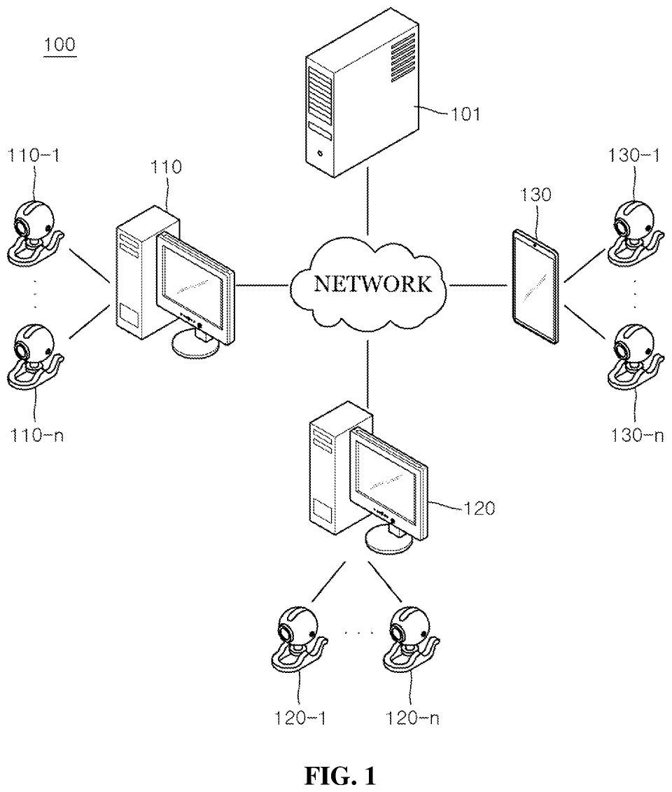

FIG. 1 is a diagram showing a configuration of a system for remotely providing a video service in a multi-camera environment according to an exemplary embodiment.

Referring to FIG. 1, a system 100 for remotely providing a video service in a multi-camera environment (hereinafter, “system”) may include a server 101, a plurality of participant terminals 110, 120, and 130, and a plurality of video recording devices 110-1 to 110-n, 120-1 to 120-n, and 130-1 to 130-n. The system 100 may share videos recorded by the plurality of video recording devices 110-1 to 110-n, 120-1 to 120-n, and 130-1 to 130-n among users who manipulate the plurality of participant terminals 110, 120, and 130. In other words, the system 100 may provide the videos to the plurality of participant terminals 110, 120, and 130 through a network.

The video service in accordance with the exemplary embodiment may be applied to tele-education. In this case, one teacher and one student may participate, or one teacher and a plurality of students may participate. For example, a teacher may manipulate the first participant terminal 110, and two students may manipulate the second participant terminal 120 and the third participant terminal 130.

The server 101 and the plurality of participant terminals 110, 120, and 130 may be connected through a wired or wireless network to communicate. The wired or wireless network is a connection structure in which nodes, such as a terminal and a server, may exchange information with each other. Examples of such a network include, but are not limited to, the Internet, a local area network (LAN), a wireless LAN, a wide area network (WAN), a personal area network (PAN), a third generation (3G) network, a fourth generation (4G) network, a fifth generation (5G) network, a Wi-Fi network, a Bluetooth network, a near field communication (NFC) network, a radio frequency identification (RFID) network, a home network, etc.

The plurality of participant terminals 110, 120, and 130 may receive or transmit a video through the network and output the video to users or participants. The plurality of participant terminals 110, 120, and 130 may include various devices, such as a smartphone, a cellular phone, a tablet personal computer (PC), a desktop computer, a laptop computer, etc., but are not limited thereto. The users of the plurality of participant terminals 110, 120, and 130 may manipulate the plurality of participant terminals 110, 120, and 130 and may be interpreted as participants in the video service of the present invention. The users of the plurality of participant terminals 110, 120, and 130 may also be referred to as “participants” below.

The plurality of video recording devices 110-1 to 110-n, 120-1 to 120-n, and 130-1 to 130-n may be connected to the participant terminals 110, 120, and 130 to implement a “multi-camera environment.” The multi-camera environment may be understood as a situation in which several video recording devices record videos of the participants who manipulate the participant terminals 110, 120, and 130 and surroundings of the participants. For example, the video recording device 110-1 may record a video of the participant's face, and the video recording devices 110-1 to 110-n other than the video recording device 110-1 may record videos of the participant's body parts other than the face and specific objects around the participant. Accordingly, the video recording devices 110-1 to 110-n may be located at several points around the first participant terminal 110 to generate videos.

The plurality of video recording devices 110-1 to 110-n, 120-1 to 120-n, and 130-1 to 130-n or the plurality of participant terminals 110, 120, and 130 may generate videos of the participants and surroundings of the participants and share the videos through the network. For example, the plurality of video recording devices 110-1 to 110-n may be connected to the first participant terminal 110 and transmit videos of the surroundings to the network through the first participant terminal 110. Alternatively, the first participant terminal 110 may include a communication module and a video recorder, for example, a webcam, therein to directly generate and transmit a video of the surroundings to the network. The video transmitted to the network may be shared with other participant terminals.

The server 101 may control the flow of videos transmitted or received by the plurality of participant terminals 110, 120, and 130 or relay the videos. For example, the server 101 may transmit a video transmitted by the first participant terminal 110, a first participant video, to the second participant terminal 120 and the third participant terminal 130. The second participant terminal 120 and the third participant terminal 130 may output the first participant video on the screens to show the first participant video to the second participant and the third participant, respectively. On the other hand, the server 101 may transmit a video transmitted by the second participant terminal 120, a second participant video, and a video transmitted by the third participant terminal 130, a third participant video, to the first participant terminal 110. The first participant terminal 110 may output the second and third participant videos on the screen to show the second and third participant videos to the first participant. Then, each of the plurality of participant terminals 110, 120, and 130 simultaneously outputs the first to third participant videos, and each participant can see all the first to third participant videos through the corresponding participant terminal.

The server 101 may give administrative authority to determine whether to change the first to third participant videos output to at least one of the plurality of participant terminals 110, 120, and 130. The participant terminal given the administrative authority may allow or prevent changes in the first to third participant videos output to other participant terminals. For example, the first participant terminal 110 given the administrative authority may give authority to change videos to the second participant terminal 120 but not to the third participant terminal 130. Then, the second participant may change the first to third participant videos output on the screen of the second participant terminal 120 through input manipulations, but the third participant may not change the first to third participant videos output on the screen of the third participant terminal 130.

Also, the participant terminal given the administrative authority may allow or prevent other participant terminals from providing participant attention information representing a changed state of the first to third participant videos. For example, the first participant terminal 110 given the administrative authority may give access authority to the second participant terminal 120 but not to the third participant terminal 130. Then, the second participant terminal 120 may provide participant attention information, and the second participant may check a changed state of the first to third participant videos. However, the third participant terminal 130 may not provide participant attention information, and the third participant may not check a changed state of the first to third participant videos.

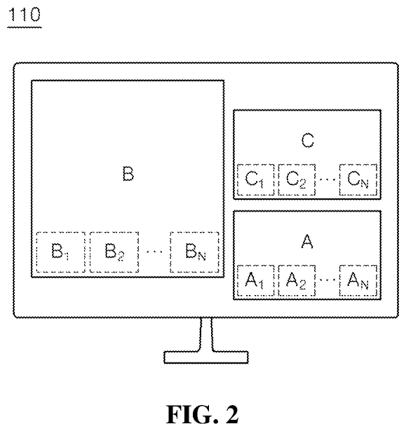

FIG. 2 is an example diagram of a screen output by one of a plurality of participant terminals according to an exemplary embodiment.

Referring to FIG. 2, the screen of one participant terminal may be shown. The participant terminal may output videos received from other participant terminals together with a video generated by the participant terminal. The video of the participant terminal and the videos of the other participant terminals may all be output on the screen together and disposed in separate regions, a region of attention and peripheral regions. The video of the participant terminal and the videos of the other participant terminals may also be output as thumbnails, that is, mini videos.

The region of attention may be understood as a region that is one region of the screen in which a video is enlarged to the largest size and displayed. The region of attention may be disposed at any position, on one side or at the center, only to stand out from the peripheral regions to a participant. As shown in the drawing, the region of attention may be disposed on one side, for example, the left side, of the screen, and the peripheral regions may be concentrated and arranged in the remaining area (see B in FIG. 2).

On the other hand, the peripheral regions may be understood as regions other than the region of attention in which videos are reduced to be smaller than a video in the region of attention and displayed. The peripheral regions may be disposed at any positions, on one side or at the center, only to highlight the region of attention. As shown in the drawing, the peripheral regions may be concentrated and arranged on the other side of the screen, for example, the right side (a region not overlapping the region of attention). Also, the region of attention and the peripheral regions may be formed in various shapes and may not be limited to rectangles, unlike what is shown in the drawing (see A and C in FIG. 2).

In the screen of one participant terminal, a video of the participant terminal and a video of another participant terminal may be output using the following method. According to a first method for a case in which two participants exchange videos, a video of one participant terminal may be disposed in a peripheral region, and a video of the other participant terminal may be disposed in the region of attention. The video of the participant terminal may be recorded by a video recording device that interoperates with the participant terminal, and the video of the other participant terminal may be recorded by a video recording device that interoperates with the other participant terminal. For example, the first participant terminal 110 may display a video B of the second participant terminal in the region of attention and display a video A of the first participant terminal 110 in a peripheral region.

According to a second method for a case in which three participants exchange videos, a video of one participant terminal and a video of another participant terminal may be disposed in peripheral regions, and a video of still another participant terminal may be disposed in the region of attention. The video of the still other participant terminal may be recorded by a video recording device that interoperates with the still other participant terminal. For example, the first participant terminal 110 may display the video B of the second participant terminal in the region of attention and display the video A of the first participant terminal 110 and a video C of the third participant terminal side by side in peripheral regions.

A difference between the first method and the second method may be whether one of two or more participants may be selected for the region of attention. According to the first method, the first participant terminal 110 outputs only the video B of the second participant terminal in the region of attention. On the other hand, according to the second method, the first participant terminal 110 may selectively output the video B of the second participant terminal or the video C of the third participant terminal in the region of attention. When the first participant terminal 110 outputs the video B of the second participant terminal in the region of attention as shown in the drawing, the video C of the third participant terminal may be output in the region of attention. In reverse, when the first participant terminal 110 outputs the video C of the third participant terminal in the region of attention, the video B of the second participant terminal may be output in the region of attention.

A video of a participant terminal and a video of another participant terminal may also be output as thumbnails. The thumbnail videos may be output on one side of the region of attention and a peripheral region to overlap a video output in the entire region of attention or the entire peripheral region. In the screen of the participant terminal, the thumbnail videos of the participant terminal may be output at the lower end of the peripheral region, and the thumbnail videos of the other participant terminal may be output at the lower end of the region of attention. For example, according to the first method for a case in which two participants exchange videos, the video B of the second participant terminal may be output in the region of attention in the screen of the first participant terminal 110, and thumbnail videos B₁, B₂, . . . , and B_{N} thereof may be output at the lower end of the region of attention. Also, the video A of the first participant terminal 110 may be output in the peripheral region, and thumbnail videos A₁, A₂, . . . , and A_{N} thereof may be output at the lower end of the peripheral region.

Alternatively, in the screen of a participant terminal, thumbnail videos of a participant terminal and another participant terminal may be output at the lower end of peripheral regions, and thumbnail videos of still another participant terminal may be output at the lower end of the region of attention. For example, according to the second method for a case in which three or more participants exchange videos, the video B of the second participant terminal may be output in the region of attention in the screen of the first participant terminal 110, and the thumbnail videos B₁, B₂, . . . , and B_{N} thereof may be output at the lower end of the region of attention. The video A of the first participant terminal 110 may be output in the peripheral region, and the thumbnail videos A₁, A₂, . . . , and A_{N} thereof may be output at the lower end of the peripheral region. Also, the video C of the third participant terminal 130 may be output in the peripheral region, and thumbnail videos C₁, C₂, . . . , and C_{N} thereof may be output at the lower end of the peripheral region.

Meanwhile, when a participant terminal receives a specific input manipulation from a participant, the participant terminal may output a video of another participant terminal in the region of attention. In other words, a video output in the region of attention may be changed so that a video that has not been output in the region of attention may be output in the region of attention. Changed videos may include not only videos displayed in each entire region but also thumbnail videos. Changing a video output in the region of attention through a specific input manipulation as described above may be defined as “individual attention.”

For example, in the drawing, the first participant terminal 110 may receive a click input or one touch input for the video C of the third participant terminal in the peripheral region from the first participant. Then, the first participant terminal 110 may output the video C of the third participant terminal in the region of attention. At the same time, not the thumbnail videos B₁, B₂, . . . , and B_{N} of the video B of the second participant terminal but the thumbnail videos C₁, C₂, . . . , and C_{N} of the video C of the third participant terminal may be output at the lower end of the region of attention. Alternatively, in the drawing, the first participant terminal 110 may receive a click input or one touch input for the thumbnail video C₁ of the video C of the third participant terminal in the peripheral region from the first participant. Then, the first participant terminal 110 may output the thumbnail video C₁ of the video C of the third participant terminal in the region of attention. At the same time, not the thumbnail videos B₁, B₂, . . . , and B_{N} of the video B of the second participant terminal but the thumbnail videos C₁, C₂, . . . , and C_{N} of the video C of the third participant terminal may be output at the lower end of the region of attention.

When a participant terminal performs individual attention, a changed video in the region of attention is not output to other participant terminals, and thus other participants are unaware of the individual attention. For example, even when the second participant terminal performs individual attention on the first thumbnail video A₁ of the video A of the first participant terminal 110, that is, outputs the first thumbnail video A₁ in the region of attention in the second participant terminal, the first participant terminal 110 may not reflect the state in which the first thumbnail video A₁ of the video A of the first participant terminal 110 is output to the second participant terminal. The first participant terminal 110 may maintain the video A of the first participant terminal 110 as it is. The third participant terminal may also perform individual attention on the second thumbnail video A₂ of the video A of the first participant terminal 110. This is because the first participant terminal 110 may not simultaneously show the changed video states of the second and third participant terminals in one peripheral region.

Unlike the above-described case of three or more participants, however, when there are two participants and one participant terminal performs individual attention, a changed video in the region of attention is output to the other participant terminal, and thus the other participant may notice the changed video. For example, when the second participant terminal performs individual attention on the first thumbnail video A₁ of the video A of the first participant terminal 110, that is, outputs the first thumbnail video A₁ in the region of attention in the second participant terminal, the first participant terminal 110 may output the first thumbnail video A₁ of the video A of the first participant terminal 110.

Meanwhile, when a specific input manipulation is received from a participant, a participant terminal may cause a video of another participant terminal to be output in the regions of attention of all participant terminals. In other words, videos output in the regions of attention of all the participant terminals may be forcibly replaced, that is, changed. Changed videos may include not only videos displayed in each entire region but also thumbnail videos. Changing a video output in the region of attention through a specific input manipulation as described above may be defined as “forced attention.”

For example, in the drawing, the first participant terminal 110 may receive a double-click input or two touch inputs for the video C of the third participant terminal in the peripheral region from the first participant. Then, the first participant terminal 110 may output the video C of the third participant terminal in the region of attention. At the same time, not the thumbnail videos B₁, B₂, . . . , and B_{N} of the video B of the second participant terminal but the thumbnail videos C₁, C₂, . . . , and C_{N} of the video C of the third participant terminal may be output at the lower end of the region of attention. Such a video change may also be made in the regions of attention of the second and third participant terminals simultaneously. Alternatively, in the drawing, the first participant terminal 110 may receive a double-click input or two touch inputs for the thumbnail video C₁ of the video C of the third participant terminal in the peripheral region from the first participant. Then, the first participant terminal 110 may output the thumbnail video C₁ of the video C of the third participant terminal in the region of attention. At the same time, not the thumbnail videos B₁, B₂, . . . , and B_{N} of the video B of the second participant terminal but the thumbnail videos C₁, C₂, . . . , and C_{N} of the video C of the third participant terminal may be output at the lower end of the region of attention. Such a video change may also be simultaneously made in the regions of attention of the second and third participant terminals.

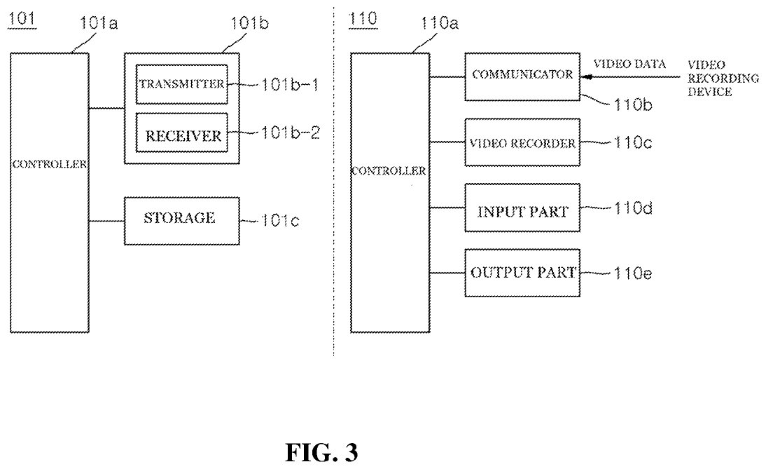

FIG. 3 is a set of block diagrams of a server and a participant terminal according to an exemplary embodiment.

Referring to FIG. 3, the server 101 may include a controller 101a, a communicator 101b, and a storage 101c.

The communicator 101b may include a transmitter 101b-1 and a receiver 101b-2. The communicator 101b may exchange information or data with a plurality of participant terminals through the transmitter 101b-1 and the receiver 101b-2. The receiver 101b-2 may receive videos recorded by video recording devices connected to each participant terminal or a signal for a video change in accordance with an input manipulation of each participant from a plurality of participant terminals. The transmitter 101b-1 may transmit the videos received from the plurality of participant terminals back to the plurality of participant terminals or transmit a video changed in accordance with an input manipulation of each participant to the plurality of participant terminals.

The controller 101a may control the communicator 101b to output videos of all participant terminals to all the participant terminals. As an example, when the video service is remotely provided between two participants who are exposed to a multi-camera environment, the controller 101a may receive a first participant video from at least one video recording device of a first participant and receive a second participant video from at least one video recording device of a second participant through the communicator 101b. To output both the first and second participant videos to the first and second participants through the communicator 101b, the controller 101a may transmit the first participant video to the second participant terminal and transmit the second participant video to the first participant terminal. After receiving an input manipulation from at least one of the first participant terminal and the second participant terminal through the communicator 101b, the controller 101a may change the first or second participant video in accordance with the input manipulation and provide the changed participant video to the first and second participant terminals.

As another example, when the video service is remotely provided among three or more participants who are exposed to a multi-camera environment, the controller 101a may receive a third participant video from a third participant terminal and transmit the third participant video to first and second participant terminals through the communicator 101b in addition to the above-described example. On the other hand, the controller 101a may also transmit first and second participant videos to the third participant terminal through the communicator 101b.

When three or more participants participate in the video service, one participant's individual attention on another participant may not be output to the other participant. As described above, this is because a state in which two or more other participants change a video of one participant is not reflected in the same region of participant terminals.

The storage 101c may store videos of participant terminals. The stored videos may be provided again upon a participant's request or sold commercially. As an example, when an exemplary embodiment is applied to tele-education, a participant who is a student may request a video including a participant who is a teacher, and the controller 101a may read and provide the video. The read video may be used for a student's review or as evidence in a dispute between a teacher and a student. As another example, a stored video including a teacher as a participant may be sold commercially on an online platform.

Also, videos of a plurality of participant terminals may be time-synchronized. For example, in a multi-camera environment, there may be a plurality of videos of the first participant terminal 110, and the videos may be output as thumbnail videos. The plurality of videos, thumbnail videos, may be recorded at the same time and stored in the storage 101c in a time-synchronized manner. Accordingly, when a participant receives the previously stored plurality of thumbnail videos and plays the plurality of thumbnail videos at a specific time point, the plurality of thumbnail videos may dynamically show images at that time point.

Meanwhile, a participant terminal, for example, the first participant terminal 110 in the drawing, may include a controller 110a, a communicator 110b, a video recorder 110c, an input part 110d, and an output part 110e. The controller 110a may control the communicator 110b, the video recorder 110c, the input part 110d, and the output part 110e.

The communicator 110b may exchange information or data with an external device. The communicator 110b may receive video data obtained by recording a participant and surroundings of the participant from the video recording devices 110-1 to 110-n and transmit the video data to the server 101. Alternatively, the communicator 110b may transmit video data recorded by the video recorder 110c included in the first participant terminal 110 to the server 101.

The input part 110d may receive an input manipulation from the participant. The input part 110d may receive a touch on the screen or a click of the mouse as an input manipulation.

The output part 110e may output videos of a plurality of participants to the participant. For example, the output part 110e may include a display device, audio device, etc.

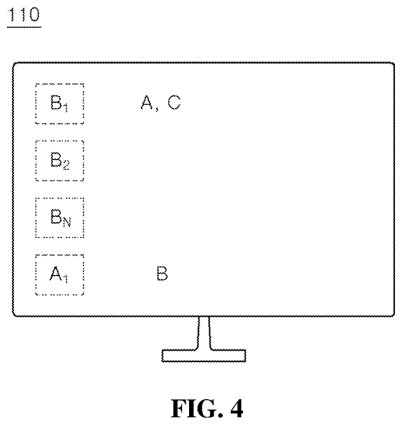

FIG. 4 is an example diagram of a participant attention state output by one of a plurality of participant terminals according to an exemplary embodiment.

Referring to FIG. 4, a screen showing an attention state of a participant terminal may be displayed. Through the attention state screen, the participant terminal may show participants who are output in the regions of attention by all participants currently using the video service.

For example, in the attention state screen, the first participant terminal 110 may show a video output in the region of attention and by which participants the video is output in the regions of attention. When the first participant selects a specific menu to display the attention state, the attention state screen shown in the drawing may be output through the first participant terminal 110. The first participant terminal 110 and the third participant terminal may currently be outputting the first thumbnail video B₁ of the video B of the second participant terminal in the regions of attention, and the second participant terminal may currently be outputting the first thumbnail video A₁ of the video A of the first participant terminal 110 in the region of attention. In this case, videos that are gaining no attention, that is, the second and N^{th} thumbnail videos B₂ and B_{N} of the video B of the second participant terminal 120, may not be output.

When the service in accordance with the exemplary embodiment is applied to tele-education, a first participant who is a teacher can check screens viewed by students, the second and third participants, through the first participant terminal 110.

To output the attention state screen, the first participant terminal 110 may receive participant attention information from the server and use the participant attention information. The server may transmit or receive videos of the first to third participant terminals including thumbnail videos or change a video output in the region of attention by receiving an input manipulation from the first to third participant terminals. The server may identify videos output in the regions of attention of the first to third participant terminals in accordance with the video change result and generate participant attention information.

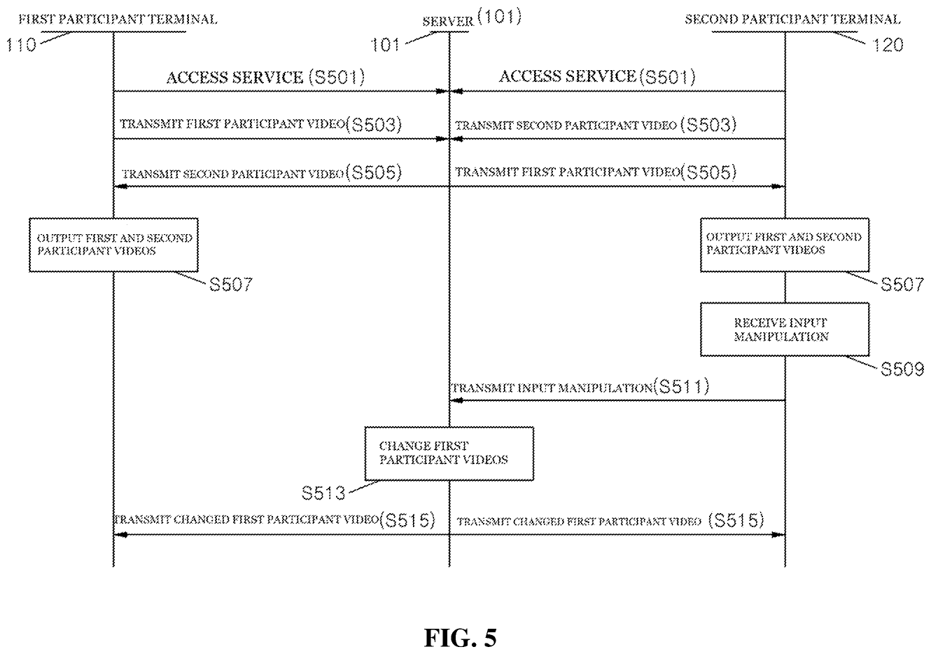

FIG. 5 is a first sequential diagram illustrating operations of a system for remotely providing a video service in a multi-camera environment according to an exemplary embodiment.

Referring to FIG. 5, first operations are illustrated in which the system for remotely providing a video service in a multi-camera environment changes a participant video in accordance with an input manipulation of a participant. In the operations, two participants may use the video service on a one-to-one basis.

The first participant terminal 110 and the second participant terminal 120 may access the service in accordance with an exemplary embodiment (operation S501). The first participant terminal 110 and the second participant terminal 120 may access the service by executing a previously installed application.

To access a detailed service, a quick response (QR) code may be used in the system according to the exemplary embodiment. For example, when the video service in accordance with the exemplary embodiment is applied to tele-education, the server 101 may generate a plurality of study groups (study rooms). Each study group may include a teacher and one or more students. To access a specific study group, a new student may join the study group by scanning a QR code provided by the server 101. In the drawing, the second participant may access the service through a separate terminal, for example, a desktop computer, and then the second participant terminal 120, for example, a smartphone, may scan the QR code provided by the server 101 through the desktop computer. Then, the second participant may join the study group linked with the QR code.

The first participant terminal 110 may transmit a first participant video in which the first participant and the surroundings are recorded to the server 101, and the second participant terminal 120 may transmit a second participant video in which the second participant and the surroundings are recorded to the server 101 (operation S503).

To output all the participant videos to each of the participant terminals, the server 101 may transmit the first participant video to the second participant terminal 120 and transmit the second participant video to the first participant terminal 110 (operation S505). Each of the first participant terminal 110 and the second participant terminal 120 may output both the received video and the video recorded by itself.

Each of the first participant terminal 110 and the second participant terminal 120 may output the first and second participant videos (operation S507).

The second participant terminal 120 of the plurality of participant terminals may receive an input manipulation for changing a video, for example, outputting a specific thumbnail video in the region of attention, from the second participant (operation S509). The second participant terminal 120 may transmit the input manipulation to the server 101 (operation S511). The input manipulation may be for outputting one thumbnail video of the first participant video in the entire region of attention from the second participant's point of view.

The server 101 may change the first participant video in accordance with the input manipulation (operation S513). The server 101 may transmit the changed first participant video back to the first participant terminal 110 and the second participant terminal 120 (operation S515). The first participant terminal 110 and the second participant terminal 120 may output both the changed first participant video and the second participant video.

The drawing corresponds to a case in which two participants use the service, and thus a video change of a participant may be shown to the other participant. In the first operations, two participants participate in the remote service, and a first participant can see a first participant video changed by a second participant.

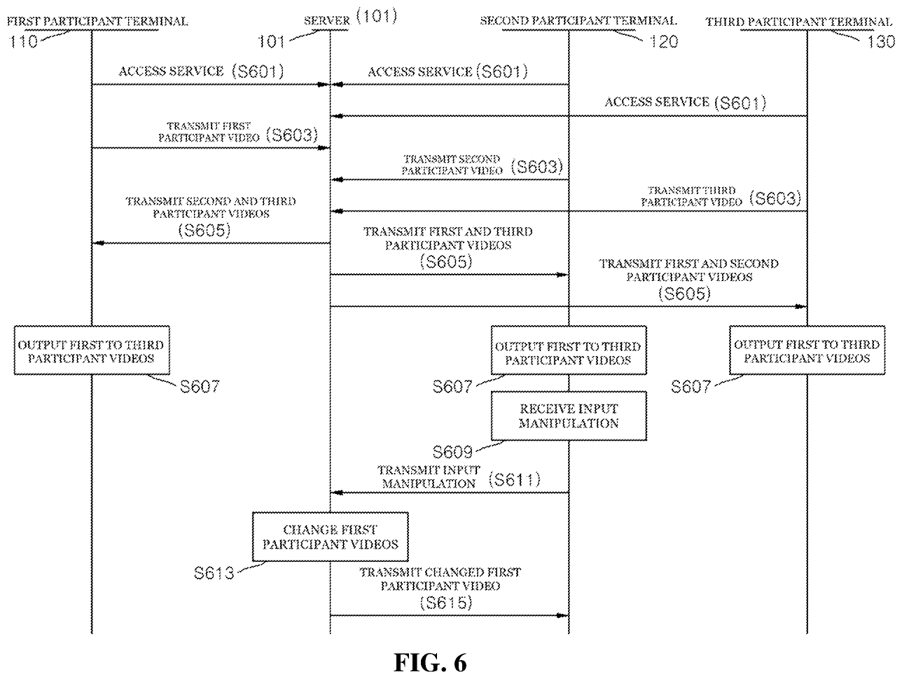

FIG. 6 is a second sequential diagram illustrating operations of a system for remotely providing a video service in a multi-camera environment according to an exemplary embodiment.

Referring to FIG. 6, second operations are illustrated in which the system for remotely providing a video service in a multi-camera environment changes a participant video in accordance with an input manipulation of a participant. In the operations, three or more participants may use the video service.

The first participant terminal 110, the second participant terminal 120, and the third participant terminal 130 may access the service in accordance with the exemplary embodiment (operation S601). The first participant terminal 110, the second participant terminal 120, and the third participant terminal 130 may access the service by executing a previously installed application.

To access a detailed service, a QR code may be used in the system according to the exemplary embodiment. For example, when the video service in accordance with the exemplary embodiment is applied to tele-education, a third participant may access the service through a separate terminal, for example, a desktop computer, and then the third participant terminal 130, for example, a smartphone, may scan the QR code provided by the server 101 through the desktop computer. Then, the third participant may join a study group linked with the QR code.

The first participant terminal 110 may transmit a first participant video in which a first participant and the surroundings are recorded to the server 101, the second participant terminal 120 may transmit a second participant video in which a second participant and the surroundings are recorded to the server 101, and the third participant terminal 130 may transmit a third participant video in which the third participant and the surroundings are recorded to the server 101 (operation S603).

To output all the participant videos to each of the participant terminals, the server 101 may transmit the second and third participant videos to the first participant terminal 110, transmit the first and third participant videos to the second participant terminal 120, and transmit the first and second participant videos to the third participant terminal 130 (operation S605).

Each of the first participant terminal 110, the second participant terminal 120, and the third participant terminal 130 may output the first to third participant videos (operation S607).

The second participant terminal 120 among the plurality of participant terminals may receive an input manipulation for changing a video, for example, outputting a specific thumbnail video in the region of attention, from the second participant (operation S609). The second participant terminal 120 may transmit the input manipulation to the server 101 (operation S611). The input manipulation may be for outputting one thumbnail video of the first participant video in the entire region of attention from the second participant's point of view.

The server 101 may change the first participant video in accordance with the input manipulation (operation S613). The server 101 may transmit the changed first participant video back to only the second participant terminal 120 which has transmitted the input manipulation (operation S615). The first participant terminal 110, the second participant terminal 120, and the third participant terminal 130 may output all the first to third participant videos. Here, the second participant terminal 120 may output the first participant video changed in accordance with the input manipulation, whereas the first participant terminal 110 and the third participant terminal 130 may output the first participant video without the change. In the second operations, three or more participants participate in the remote service, and a first participant may not see a first participant video changed by a second participant.

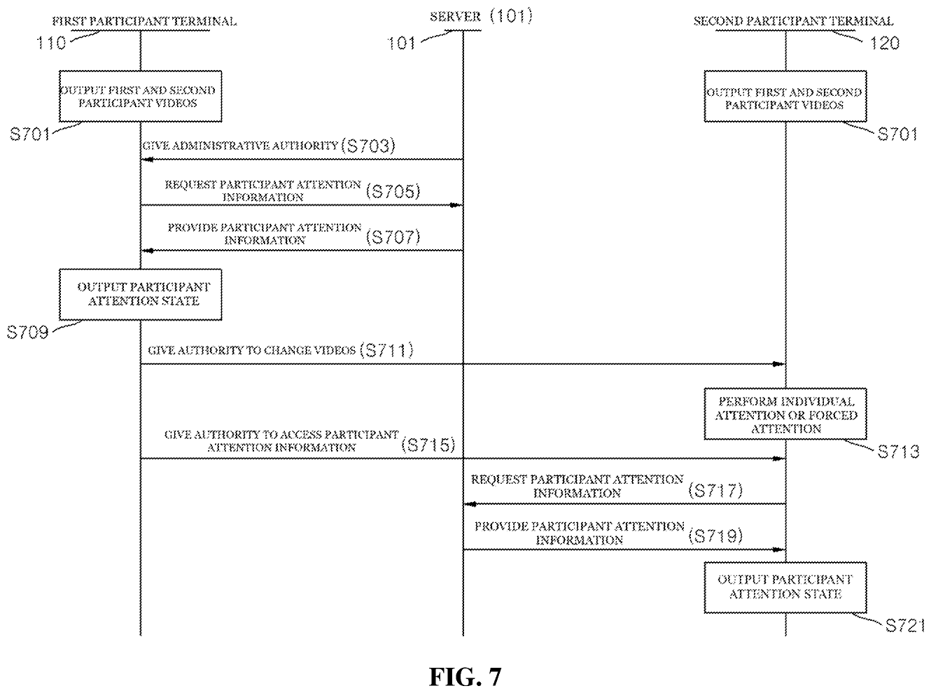

FIG. 7 is a third sequential diagram illustrating operations of a system for remotely providing a video service in a multi-camera environment according to an exemplary embodiment.

Referring to FIG. 7, operations are illustrated in which the system for remotely providing a video service in a multi-camera environment provides administrative authority including authority to change videos and authority to access participant attention information.

The first participant terminal 110 and the second participant terminal 120 may access the service in accordance with the exemplary embodiment to output first and second participant videos (operation S701).

The server 101 may give administrative authority to one of a plurality of participants. In the drawing, the first participant terminal 110 may receive administrative authority from the server 101 (operation S703). The first participant terminal 110 may output a changed video in the region of attention through the authority to change videos and output an attention state through the authority to access participant attention information.

To output the attention state, the first participant terminal 110 may request participant attention information from the server 101 (operation S705). The server 101 may provide participant attention information (operation S707). The first participant terminal 110 may output an attention state of a participant on the basis of the participant attention information (operation S709).

The first participant terminal 110 having the administrative authority may give the authority to change videos to the second participant terminal 120 (operation S711). The second participant terminal 120 may perform individual attention and/or forced attention in accordance with the content of the authority to change videos (operation S713). When the first participant terminal 110 does not give the authority to change videos, the second participant terminal 120 may perform neither of individual attention and forced attention.

The first participant terminal 110 having the administrative authority may determine whether the second participant terminal 120 outputs an attention state. Accordingly, the first participant terminal 110 may give authority to access participant attention information (operation S715). The second participant terminal 120 may request participant attention information from the server 101 according to the authority to access participant attention information (operation S717). The server 101 may provide participant attention information to the second participant terminal 120 (operation S719). The second participant terminal 120 may output an attention state of a participant on the basis of the participant attention information (operation S721). When the first participant terminal 110 does not give the authority to access participant attention information, the second participant terminal 120 may not output the attention state.

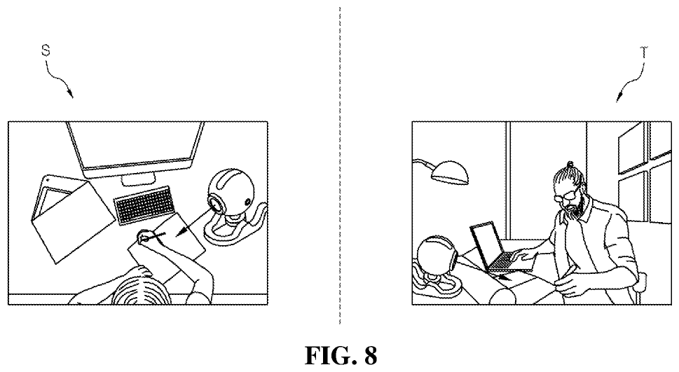

FIG. 8 is a set of example diagrams of a case in which a student and a teacher participate in a system for remotely providing a video service in a multi-camera environment according to an exemplary embodiment.

Referring to FIG. 8, the video service in accordance with the exemplary embodiment may be applied to tele-education between a teacher and a student. The teacher and the student may correspond to a first participant and a second participant below, respectively.

An internal camera of a first participant terminal, a laptop computer, may record the face of the teacher who is the first participant, and an additional webcam may record a hand or notebook of the teacher. The first participant video may include a video recorded by the internal camera and a video recorded by the webcam, and the two videos may be output in one area in the screen of a second participant terminal or as thumbnails (see S in the drawing).

Meanwhile, an internal camera of the second participant terminal, a desktop computer, may record the face of the student who is the second participant, and an additional webcam may record a hand or notebook of the student. The second video may include a video recorded by the internal camera and a video recorded by the webcam, and the two videos may be output in one area in the screen of the first participant terminal or as thumbnails (see T in the drawing).

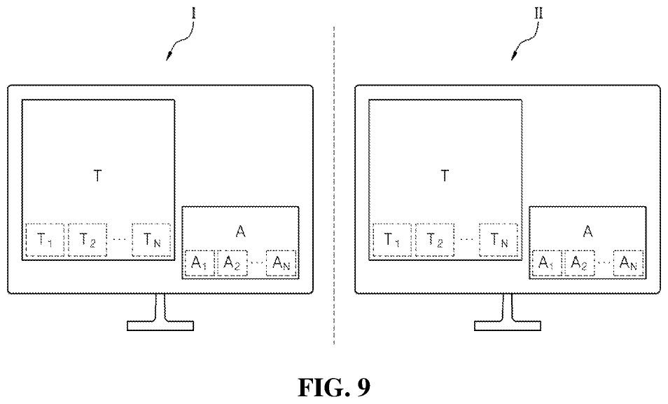

FIG. 9 is a first example of screens output by terminals of a student and a teacher when the student and the teacher participate in a system for remotely providing a video service in a multi-camera environment according to an exemplary embodiment.

FIG. 9 shows an example of screens that are output to terminals of a teacher and a student when the video service in accordance with the exemplary embodiment is applied to tele-education between the teacher and the student. I may indicate the screen of the student's terminal, and II may indicate the screen of the teacher's terminal.

At first, the terminal of the teacher may output a video of the student in the region of attention, and the terminal of the student may output a video of the teacher in a peripheral region. However, when the teacher applies an input manipulation, for example, a double click, to the video of himself or herself, the video of the teacher may be simultaneously output in the region of attention in the teacher's terminal and the region of attention in the student's terminal, and the video of the student may be simultaneously output in the peripheral regions. The drawing may represent a forced attention state as described above.

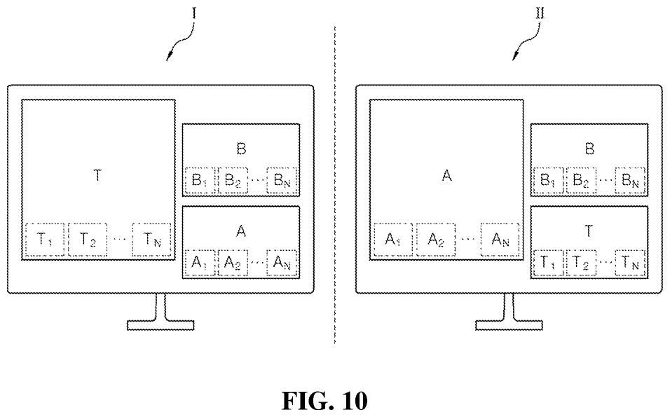

FIG. 10 is a second example of screens output by terminals of a student and a teacher when students and the teacher participate in a system for remotely providing a video service in a multi-camera environment according to an exemplary embodiment.

FIG. 10 shows an example of screens that are output to terminals of a teacher and a student when the video service in accordance with the exemplary embodiment is applied to tele-education between the teacher and two or more students. I may indicate the screen of a first student's terminal, and II may indicate the screen of the teacher's terminal.

The terminal of the first student may output a video of the teacher in the region of attention and output a video of the first student and a video of a second student in peripheral regions. On the other hand, the terminal of the teacher may output the video of the first student in the region of attention and output the video of the second student and the video of the teacher in peripheral regions.

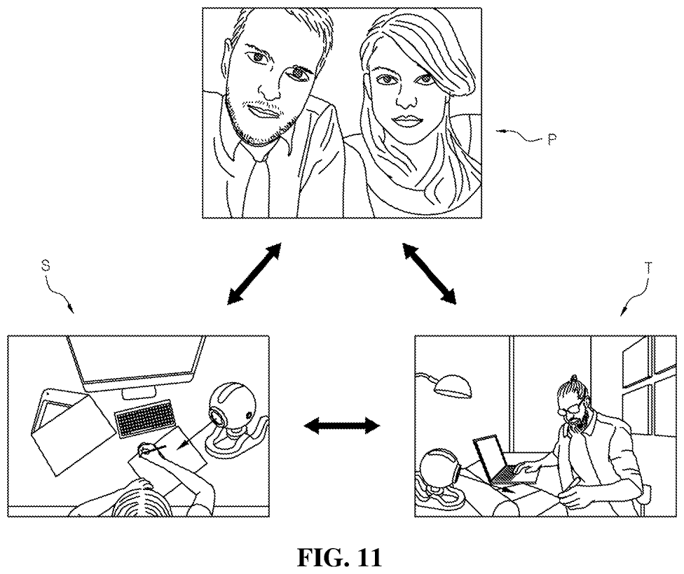

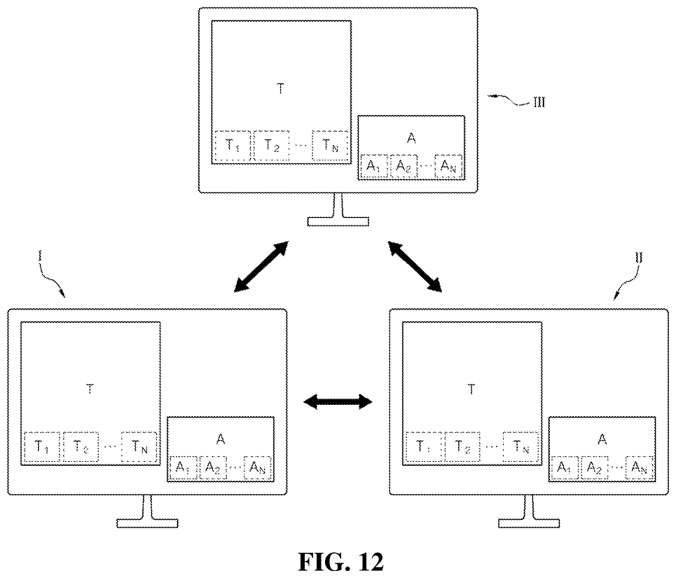

FIG. 11 is a set of example diagrams of a case in which a student, a teacher, and parents participate in a system for remotely providing a video service in a multi-camera environment according to an exemplary embodiment, that is, examples of screens output to terminals of the student, the teacher, and the parents in accordance with FIG. 12.

Referring to FIG. 11, the video service in accordance with the exemplary embodiment may be applied to tele-education among the teacher, the student, and the parents. The teacher, the student, and the parents may correspond to a first participant T, a second participant S, and a third participant P below, respectively. The parents may receive both a video of the teacher and a video of the student through the terminal thereof. The terminal of the student and the terminal of the teacher provide a forced attention state and thus may have the same screen configuration (see I and II of the drawing). The terminal of the parents may interoperate with the terminal of the student of the terminal of the teacher and thus may receive the same videos as the interoperating terminal. Accordingly, the terminal of the parents may have the same screen configuration as the terminal of the student of the terminal of the teacher (see III of the drawing).

According to the above-described exemplary embodiments, participant videos obtained by variously recording each participant and surroundings of the participant are provided to all participants. Accordingly, it is possible to increase interaction between participants and strengthen realism.

Also, according to the exemplary embodiments, when a video service is applied to the education field, it is possible to increase immersion of students, implement a visiting mode in which parents of students checks all videos of a teacher and students, and store the videos of the teacher and students so that the stored videos can be used later for a review.

Elements, units, blocks, or modules used in the exemplary embodiment may be implemented in software, such as tasks, classes, subroutines, processes, objects, execution threads, or programs which are executed in a certain region in a memory, or hardware, such as field programmable gate arrays (FPGAs) or application-specific integrated circuits (ASICs), and may also be implemented in a combination of software and hardware. The elements, units, etc. may be included in a computer-readable storage medium, and some portions thereof may be dispersedly distributed to a plurality of computers. One or more elements may be implemented by one or more computing devices or a portion thereof. The devices may include, for example, PCs, server computers, handheld or laptop devices, multiprocessor systems, microcontroller-based systems, set-top boxes, programmable home appliances, network PCs, minicomputers, mainframe computers, cellular phones, personal digital assistants (PDAs), gaming devices, printers, set-top devices, media centers, or other devices, vehicle-embedded or attached computing devices, other mobile devices, distributed computing environments including any of the above systems or devices, etc.

Meanwhile, the disclosed exemplary embodiments may be implemented in the form of a recording medium in which a computer-executable program and/or instructions are stored. The instructions may be stored in the form of program code and, when executed by a processor, may generate a program module to perform operations of the disclosed exemplary embodiments. The recording medium may be implemented as a computer-readable recording medium. The computer-readable recording medium includes any type of recording medium in which computer-readable instructions are stored. For example, the computer-readable recording medium may be a read-only memory (ROM), a random access memory (RAM), magnetic tape, a magnetic disk, a flash memory, an optical data storage, etc.

The scope of the present invention is not limited to the descriptions and expressions of the exemplary embodiments clearly described above. Again, the scope of the present invention is not limited by self-evident modifications or substitutions in the technical field to which the present invention pertains.

What is claimed is:

1. A method of remotely providing a video service among a plurality of participants exposed to a multi-camera environment by a server, the method comprising:
receiving first participant videos from two or more video recording devices of a first participant;
receiving second participant videos from two or more video recording devices of a second participant; and
transmitting the first participant videos to a second participant terminal and transmitting the second participant videos to a first participant terminal to output all the first and second participant videos to the first and second participants,
wherein one of the first participant videos is generated by one of the video recording devices of the first participant, output in a region of attention in a screen of the second participant terminal, and output in a peripheral region in a screen of the first participant terminal,
another one of the first participant videos is generated by another one of the video recording devices of the first participant, output as a thumbnail in the region of attention in the screen of the second participant terminal, and output as a thumbnail in the peripheral region in the screen of the first participant terminal,
one of the second participant videos is generated by one of the video recording devices of the second participant, output in a region of attention in the screen of the first participant terminal, and output in a peripheral region in the screen of the second participant terminal, and
another one of the second participant videos is generated by another one of the video recording devices of the second participant, output as a thumbnail in the region of attention in the screen of the first participant terminal, and output as a thumbnail in the peripheral region in the screen of the second participant terminal.

2. The method of claim 1, wherein, when the first participant terminal receives an input manipulation for thumbnails of the first and second participant videos from the first participant, the first and second participant videos are output in the entire region of attention in the first participant terminal, and
when the second participant terminal receives an input manipulation for the thumbnails of the first and second participant videos from the second participant, the first and second participant videos are output in the entire region of attention in the second participant terminal.

3. The method of claim 1, wherein, when the second participant terminal receives an input manipulation for the thumbnail of the first participant video from the second participant, the first participant video is output in the entire region of attention in the second participant terminal and the entire peripheral region in the first participant terminal.

4. The method of claim 1, wherein, when the first participant terminal receives an input manipulation for the thumbnails of the first and second participant videos from the first participant or the second participant terminal receives an input manipulation for thumbnails of the first and second participant videos from the second participant, the first and second participant videos are simultaneously output in the entire regions of attention of the first and second participant terminals.

5. The method of claim 1, further comprising:
receiving an input manipulation from a participant terminal which is given authority to change videos;
changing the first or second participant videos in accordance with the input manipulation and providing the changed participant video to the first and second participant terminals; and
generating participant attention information representing a changed state of the first or second participant videos and providing the participant attention information to the first and second participant terminals.

6. The method of claim 1, further comprising giving administrative authority to the first or second participant terminals,
wherein the administrative authority includes authority to change videos to change the first or second participant video and authority to access participant attention information representing a changed state of the first or second participant videos.

7. A server for remotely providing a video service among a plurality of participants exposed to a multi-camera environment, the server comprising:
a communicator configured to transmit or receive information or data to or from a first participant terminal manipulated by a first participant and a second participant terminal manipulated by a second participant; and
a controller configured to, through the communicator, receive first participant videos from two or more video recording devices of the first participant, receive second participant videos from two or more video recording devices of the second participant, transmit the first participant videos to the second participant terminal and transmit the second participant video to the first participant terminal to output all the first and second participant videos to the first and second participants,
wherein one of the first participant videos is generated by one of the video recording devices of the first participant, output in a region of attention in a screen of the second participant terminal, and output in a peripheral region in a screen of the first participant terminal,
another one of the first participant videos is generated by another one of the video recording devices of the first participant, output as a thumbnail in the region of attention in the screen of the second participant terminal, and output as a thumbnail in the peripheral region in the screen of the first participant terminal,
one of the second participant videos is generated by one of the video recording devices of the second participant, output in a region of attention in the screen of the first participant terminal, and output in a peripheral region in the screen of the second participant terminal, and
another one of the second participant videos is generated by another one of the video recording devices of the second participant, output as a thumbnail in the region of attention in the screen of the first participant terminal, and output as a thumbnail in the peripheral region in the screen of the second participant terminal.

8. The server of claim 7, wherein the communicator transmits or receives information or data to or from a third participant terminal manipulated by a third participant,
the controller transmits a third participant video to the first and second participant terminals to output all the first to third participant videos to the first and second participants, receives an input manipulation from the first and second participant terminals, changes the first to third participant videos in accordance with the input manipulation, and provides the changed first to third participant videos to the first and second participant terminals, and
when the second participant terminal receives an input manipulation for the first participant video from the second participant, the first participant video is output in the entire region of attention in the second participant terminal, and the peripheral region of the first participant terminal is maintained in a previous output state.
